(19) United States
(12) Patent Application Publication
(10) Pub. No.: US 2003/0226140 A1
(43) Pub. Date: Dec. 4, 2003

(54) Method for managing the payment of goods and services, particularly for on-demand transmissions, and corresponding electronic wallet

(75) Inventor: Rosario D. Contarino, London (GB)

Correspondence Address: SUGHRUE MION, PLLC, 2100 Pennsylvania Avenue, NW, Washington, DC, 20037-3213, US

(73) Assignee: Anstalt OIKOS

(21) Appl. No.: 10/156,865

(22) Filed: May 30, 2002

(51) Int. Cl. H04N 7/16

(52) U.S. Cl. 725/1; 725/5

(57) ABSTRACT

It is described a method for managing the payment of goods and services is described, comprising at least the steps:

demanding for the supply of a good or service by the user;

selecting a payment form of the good or service;

charging corresponding to the good or service in the selected form;

In particular, the step of selecting a payment form provides a step of selecting to receive advertising contents.

Moreover, an electronic wallet is described, which is suitable for implementing the proposed method for managing the payment of goods and services.

### TECHNICAL FIELD

This invention relates to a method for managing the payment of goods and services.

The invention also relates to an electronic wallet suitable for implementing such a method for managing the payment of goods and services.

The invention is particularly, but not exclusively, directed to a method for managing the payment of audiovisual contents distributed to a plurality of subscribers to the service and the following description is given with reference to this field of application for convenience of illustration only.

### BACKGROUND OF THE INVENTION

As it is well known, differently from a common television set wherein the audiovisual content transmission, once a channel has been chosen, occurs according to the TV program imposed by the TV broadcaster, the on-demand mode transmission of audiovisual content allows a particular audiovisual content to be available, whether it is an entertainment program, a news or other program, only on explicit demand of the user and only when this request is made.

In order to benefit from this kind of transmission, the user must generally take out a base subscription, through which a device is provided, the device receiving the audiovisual contents according to the on-demand mode. The device is generally known as decoder and it is input-connected to an external data network and output-connected to the user display device, like for example a television set.

In known systems, each demand for transmission of a particular audiovisual content is paid individually. These transmission demands and the corresponding payments are generally managed through menus displayed by the decoder.

The most widespread payment form is the so-called pay per view form. This form involves the payment for each viewing and only after it, differently from a common television license fee, wherein payment is always made even if the viewing is not performed and it is not possible to choose the audiovisual contents for which the user wants to pay and which he wants to view.

Generally, payment is made through credit card charging or by using prepaid “scale down” cards, which must be periodically recharged and which progressively scale down the charges of the demands sent for the on-demand mode transmission of audiovisual content.

One of the problems which restrains the diffusion of transmission systems having the pay per view payment form is just the high cost of the broadcast audiovisual contents, which is totally charged to the user.

It should be also noted that the audiovisual contents broadcast according to the on-demand mode and paid in the pay per view form have high costs due to the need to pay duties for first release transmission and to the impossibility of using efficiently advertising interruptions, as it occurs in traditional television channels.

### SUMMARY OF THE INVENTION

An embodiment of this invention provides a method for managing the payment of goods and services, in particular for the on-demand mode transmission of audiovisual content, which allows the payment charge to users to be lowered in the pay per view form, overcoming the limits and drawbacks which presently trouble the on-demand video services provided according to the prior art.

The method uses the acceptance by the user of advertising contents which interrupt the transmission of the selected audiovisual content, for the partial and/or total payment of a good or service, like for example a transmission of an audiovisual content.

Another embodiment of this invention provides for an electronic wallet suitable for implementing the method for managing the payment of goods and services.

The features and advantages of the invention will be apparent from the following description of an embodiment thereof, given by way of non-limitative example.

### DETAILED DESCRIPTION

The invention relates to a method for managing the payment of goods and services, in particular the demands for transmission of audiovisual contents in the pay per view form.

The method according to an embodiment of the invention provides the use of remote services for supporting the functions available to the final users with regard to the charge of the amounts related to viewing audiovisual contents in the pay per view form.

In particular, the method for managing the payment of goods and services provides a crediting step for the user viewing of advertising contents, these contents interrupting the transmission of a selected audiovisual content.

Advantageously according to an embodiment of the invention, an electronic wallet is used, which records in the subtraction algebraic form the demands for the audiovisual content transmission in the pay per view form and in the addition algebraic form the acceptance for viewing advertising contents.

It is possible to realize such an electronic wallet by using a database whose records contain the amount corresponding to each user account. The records of this database are therefore updated when it is necessary to record a charge or a credit performed by a user.

In particular, the method provides the splitting of the contents distributed by the decoders between fee-paying audiovisual contents and advertising contents.

The term advertising content, here and the rest of the description, generally means an audiovisual content for whose viewing the user receives a credit.

In the case of advertising contents, the viewing of each advertising content involves for the user the crediting of a given amount in his electronic wallet.

On the contrary, the viewing of a fee-paying audiovisual content involves the charge of the corresponding amount in the user electronic wallet. Advantageously, the method for managing the payment of goods and services according to an embodiment of the invention provides that, before a fee-paying audiovisual content is viewed, the user chooses whether to pay totally or partially the amount due by viewing the advertising content.

In case of partial payment by viewing an advertising content, the user chooses also the desired percentages for this payment.

In substance, the method for managing the payment of goods and services according to an embodiment the invention provide the steps of:

selection by the user of an audiovisual contents he wants to display;

selection by the user of the payment form between total charge in his electronic wallet, in the credit card or partial charge against viewing of advertising contents which will interrupt periodically the viewing of the selected audiovisual content.

It is also possible to consider the case wherein the user can choose to receive advertising contents out of the viewing of fee-paying audiovisual contents, allowing therefore his electronic wallet to be recharged and the recharge amount to be used in a different moment for a fee-paying good or service.

In a preferred embodiment of the proposed method, a step is also provided for recording the preferences or profiling of the subscribers to the service, during which profiling step the users choose the advertising content categories they want to view.

For example, a user can choose advertising contents relating to his job or working field, hobbies or interests, special gifts and so on.

In this way, a user deciding to pay the service relating to the transmission of an audiovisual content by viewing advertising contents receives preferably only advertising contents which satisfy the previously provided features.

Moreover, advantageously according to an embodiment of the invention, a producer or distributor of advertising messages can decide the addressee of its own advertising contents, based on detailed information for each subscriber to the service, and eventually also the kind of audiovisual content he wants to sponsor. This producer or distributor can also decide the amount he wants to credit to the user electronic wallet for viewing each of the advertising contents thereof. Therefore the producer or distributor can focus the interest on a particular advertising content, for example when the launching on the market of the same is near, by increasing, even for a limited time period, the credit value added to the electronic wallet of the users selecting it.

It should be noted that the method according to an embodiment of the invention allows to aim precisely at the target of people to whom a particular advertising content is broadcast and makes the viewing of that advertising content certainly more efficient.

The proposed method also differs from the advertising distributed on Internet and linked to the search engines aiming at defining a certain user profile on the basis of the set search. Advantageously according to an embodiment of the invention, the addressing of the advertising content in the proposed method is as much detailed as possible, by differentiating each user univocally, even before sending the advertising content.

Moreover, due to the user ability to specify the kind of contents required, including advertising contents, it is the user himself who asks for viewing a particular advertising content, his interest on the same being therefore guaranteed.

Advantageously according to an embodiment of the invention, the method for managing the payment of services also provides additional steps for managing the information which is useful for invoicing, controlling the content access rights, profiling the final users and configuring the display devices mounted at the users' place.

In conclusion, the method according to an embodiment of the invention has the following advantages:

1. The user can choose, together with the audiovisual contents he wants to view, the kind of advertising content he wants to receive as total or partial payment for the transmission of said audiovisual content.

2. The payment for the transmissions of audiovisual content turns out to be reduced for the user due to the viewing of advertising contents. In this way, by receiving a suitable advertising messages sequence, the user can access to fee-paying contents almost free of charge.

3. The producer or distributor of advertising contents has a very detailed profiling, which is specific for each user. At present no other advertising instrument allows as much. Only the direct mailing can be compared, which is however used for newspapers and not for video messages.

4. At present no other advertising instrument guarantees to the advertising producers that the user to whom the advertising message is addressed has explicitly asked for it. This is on the contrary guaranteed by the proposed method since the user explicitly requests it for his personal interest and for paying other contents he is interested in.

Even though it has been described with reference to the payment of on-demand mode transmission of audiovisual contents, the proposed method is not limited to this embodiment.

In particular, it can be considered the possibility of using the electronic wallet according to an embodiment of the invention for managing the distribution of fee-paying information through Internet. This information can, in turn, be video files, audio files, image files, but also data files or program files. It is also possible to consider the case of payment through the electronic wallet of material goods available to the users.

The electronic wallet according to an embodiment of the invention can be also used for example for managing the accesses to fee-paying sites, through viewing advertising contents as total or partial payment of subscription fees or to single accesses to these sites.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. Method for managing the payment of goods and services comprising at least the following steps:
demanding for the supply of a good or service by the user;
selecting a payment form of the good or service by the user;
charging corresponding to the good or service in the selected form;
wherein the step of selecting a payment form provides a step of selecting to receive advertising contents.

2. The method for managing the payment of goods and services of claim 1, further comprising a crediting step corresponding to the reception of advertising contents by the user as total or partial cover of the charge.

3. The method for managing the payment of goods and services of claim 2, wherein the crediting and charging steps use an electronic wallet of the user.

4. The method for managing the payment of goods and services of claim 2, further comprising, in case of partial cover of the charge, a step of selection by the user of a percentage of crediting through the reception of advertising contents.

5. The method for managing the payment of goods and services of claim 1, further comprising a step of collecting and recording the preferences of the user, during which step the user chooses the advertising content categories and the single advertising contents he wants to receive.

6. The method for managing the payment of goods and services of claim 5, wherein the advertising content selection satisfies the recorded preferences.

7. The method for managing the payment of goods and services of claim 5, wherein the advertising contents are addressed by a producer thereof on the basis of the recorded preferences.

8. The method for managing the payment of goods and services of claim 1, wherein the advertising contents are addressed by a producer thereof on the basis of the audiovisual contents.

9. The method for managing the payment of goods and services of claim 1, further comprising additional steps for managing the information which is useful for invoicing, controlling the content access rights and configuring the display devices mounted at the users' place.

10. The method for managing the payment of goods and services of claim 1, wherein the supply demand comprises a demand for a transmission of audiovisual contents and wherein the advertising contents interrupt the transmission of the audiovisual contents.

11. The method for managing the payment of goods and services of claim 1, wherein the supply demand comprises a demand of distribution of fee-paying information through Internet.

12. The method for managing the payment of goods and services of claim 1, wherein the supply request comprises a request of managing the accesses to fee-paying sites.

13. The method for managing the payment of goods and services of claim 1, wherein the supply demand comprises a demand of buying a material good.

14. Electronic wallet for managing the payment of goods and services provided to a user and suitable to record charges corresponding to the selected goods and services, the electronic wallet providing a credit corresponding to a selection to receive advertising contents by the user as total or partial cover of the charges.

15. The electronic wallet of claim 14, wherein it provides, in case of partial cover of the charges, a selection of a partial charge percentage by the user.

16. The electronic wallet of claim 14, wherein it provides an update during each credit and charge performed by said user.

17. Method for supplying goods and services to subscribers comprising at least the following steps:
receiving a demand for the supply of a good or service by a subscriber;
storing the selection of a payment form of the good or service by the subscriber;
supplying a selected good or service to the subscriber;
charging corresponding to the selected good or service in the selected payment form;
wherein the selection a payment form comprises a step of selecting to receive advertising contents by the subscriber.

18. The method for supplying goods and services of claim 17, further comprising a crediting step corresponding to the reception of advertising contents by the subscriber as total or partial cover of the charge.

19. The method for supplying goods and services of claim 18, wherein the crediting and charging steps use an electronic wallet of the subscriber.

20. The method for supplying goods and services of claim 18, further comprising, in case of partial cover of the charge, a step of selection by the subscriber of a percentage of crediting through the reception of advertising contents.

21. The method for supplying goods and services of claim 17, further comprising a step of collecting and recording the preferences of the subscribers, during which step each subscriber chooses the advertising content categories and the single advertising contents he wants to receive.

22. The method for supplying goods and services of claim 21, wherein the advertising content selection satisfies the recorded preferences.

23. The method for supplying goods and services of claim 21, wherein the advertising contents are addressed by a producer thereof on the basis of the recorded preferences.

24. The method for supplying goods and services of claim 17, wherein the advertising contents are addressed by a producer thereof on the basis of the audiovisual contents.

25. The method for supplying goods and services of claim 17, further comprising the following additional steps:
invoicing the selected goods or services starting from information given by the subscribers;
controlling the content access rights of each subscriber;
configuring the display devices mounted at the subscribers' place.

26. The method for supplying goods and services of claim 17, wherein the supply demand comprises a demand for a transmission of audiovisual contents and wherein the advertising contents interrupt the transmission of the audiovisual contents.

27. The method for supplying goods and services of claim 17, wherein the supply demand comprises a demand of distribution of fee-paying information through Internet.

28. The method for supplying goods and services of claim 17, wherein the supply demand comprises a demand of managing the accesses to fee-paying sites.

29. The method for supplying goods and services of claim 17, wherein the supply demand comprises a demand of buying a material good.
